(19) United States
(12) Patent Application Publication
(10) Pub. No.: US 2009/0289812 A1
(43) Pub. Date: Nov. 26, 2009

(54) System and Method for Providing Real-Time Dangerous Road Information Based on USN

(76) Inventors: Min-Soo Kim, Daejeon (KR); Eun-Kyu Lee, Seoul (KR); Byung-Tae Jang, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/085,148

(22) PCT Filed: Dec. 26, 2005
(86) PCT No.: PCT/KR2005/004535

§ 371 Date: May 16, 2008

(30) Foreign Application Priority Data
Nov. 18, 2005 (KR) 1020050110892

(51) Int. Cl. G08G 1/09

(52) U.S. Cl. 340/905

(57) ABSTRACT

Provided is a system and method for providing dangerous road information based on a Ubiquitous Sensor Network (USN) in real-time. The system includes: a dangerous road zone information sensing unit having a sensing function for sensing diverse information in a dangerous road zone and a computing function for extracting dangerous road information by analyzing the sensed information; a dangerous road zone information transmitting unit for transmitting the extracted dangerous road information through a short distance wireless network; a dangerous road zone information collecting unit for collecting the transmitted dangerous road information and checking duplication elimination and unification of the dangerous road information; and a dangerous road zone information providing unit for providing the dangerous road information collected and processed in the dangerous road zone information collecting unit to a Telematics vehicle approaching to the dangerous road zone in real-time through wireless communication.

### TECHNICAL FIELD

The present invention relates to a system and method for providing road information based on Ubiquitous Sensor Network (USN) in real-time; and, more particularly, to a system and method that informs a vehicle approaching to a dangerous road zone of a dangerous road information in advance using a base station after sensing the dangerous road information such as a traffic accident, discovery of obstacles, outbreak of a fire, a slippery road, road destruction and a pedestrian by establishing a sensor network infrastructure including sensors nodes and a base station in a dangerous road zone that is beyond the field of vision.

### BACKGROUND ART

A conventional method for providing dangerous road information in advance includes steps of collecting dangerous road information and providing dangerous road information.

In the conventional step of collecting dangerous road information, initial measurement is generally performed by a vehicle deriver or a charge-coupled device (CCD) camera. The initial measurement information is transmitted to a traffic information center through a telephone and a wired/wireless communication. In the traffic information center, a man directly computerizes dangerous situation information by generating them after analyzing the initial measurement information.

The conventional step of collecting dangerous road information has a difficulty in exactly collecting information of a wide region that is beyond the field of vision such as an entire inside of a tunnel and an upper part of an entire bridge since the dangerous road information is collected only by the man or the CCD camera.

Meanwhile, in the conventional steps of providing the dangerous road information, dangerous road information is provided from the traffic information center through a variable message signs (VMS) set up on the road. The method has two problems. First, a driver cannot acquire information without looking the VMS. Second, the dangerous road information cannot be provided in real-time since the dangerous road information is provided by the traffic information center.

### DISCLOSURE

### Technical Problem

It is, therefore, an object of the present invention to provide a system and method for providing dangerous road information based on Ubiquitous Sensor Network (USN) in real-time to prevent a traffic accident by sensing dangerous road information in a dangerous road zone environment such as an inside of a tunnel, an upper part of a bridge and a curved road where a vehicle driver directly cannot see, and previously providing dangerous road information before entering the dangerous road zone.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided a system for providing dangerous road information in real-time based on a Ubiquitous Sensor Network (USN), the system including: a dangerous road zone information sensing unit having a sensing function for sensing diverse information in a dangerous road zone and a computing function for extracting dangerous road information by analyzing the sensed information; a dangerous road zone information transmitting unit for transmitting the extracted dangerous road information through a short distance wireless network; a dangerous road zone information collecting unit for collecting the transmitted dangerous road information and checking duplication and unification of the dangerous road information; and a dangerous road zone information providing unit for providing the dangerous road information collected and processed in the dangerous road zone information collecting unit to a Telematics vehicle approaching to the dangerous road zone in real-time through wireless communication.

In accordance with another aspect of the present invention, there is provided a method for providing dangerous road information in real-time based on a USN, including the steps of: a) sensing candidate dangerous road information for dangerous road information; b) extracting dangerous road information from the sensed candidate dangerous road information; c) transmitting the extracted dangerous road information through a wireless network; d) collecting the transmitted dangerous road information and performing duplication elimination, unification and simplification; and e) providing the collected and processed dangerous road information to a Telematics vehicle approaching to a dangerous road zone environment in real-time.

In the present invention, a plurality of sensor nodes have a capability for sensing a fire, freezing, flood, a pedestrian, a load and road damage based on the situation of the dangerous region such as the inside of the tunnel, the upper part of the bridge and the curved road. The sensor nodes create exact dangerous road information according to each dangerous road zone by synthetically using a sensing capability based on temperature, humidity, infrared rays, heat, and laser, and own computing capability. Also, the sensor nodes sense all of the dangerous road information of the wide region such as the entire inside of the tunnel and the entire bridge based on a short distance wireless communication capability of the sensor nodes broadly mounted in the dangerous road zone, and collect the sensed dangerous road information in the base station for providing the dangerous road information service. The base station is located before start of entrance into the dangerous road zone, does not transmit the collected dangerous road information to a traffic information center, but to all vehicles entering the dangerous road in real-time through wireless communication.

Also, the base station can improve efficiency and reliability of real-time information transmission based on the dualization method for providing the real-time dangerous road information on the VMS, just as the conventional method. The base station includes a module for receiving the dangerous road information from the sensor nodes, a module for storing the received dangerous road information and a module for servicing the dangerous road information. The information stored in the dangerous road information storage can be applied to the traffic accident statistics and analysis.

The present invention directly creates the dangerous situation information by collecting and analyzing the initial measurement information by the sensor nodes having diverse synthetic sensing capabilities and the computing capability differently from the conventional dangerous road information. Since the dangerous road information collecting method using the sensor nodes does not require transmitting the measurement information to the traffic information center, a necessary time can be reduced in a process for creating the dangerous road information.

Also, the present invention can easily collect the dangerous road information of the wide region by setting the sensor nodes having a wireless networking capability in the inside of the tunnel or the upper part of the bridge and forming the wireless network between the sensor nodes differently form the step of collecting the conventional dangerous road information.

Also, the present invention can improve efficiency and reliability of real-time information transmission by directly and wirelessly providing the dangerous road information collected from the sensor nodes to the vehicle through the base station set up in a close place from the road differently from the step of providing the conventional dangerous road information.

### Advantageous Effects

The present invention can remarkably reduce traffic accidents in a black spot for the traffic accident by sensing dangerous road information in advance in a dangerous road zone environment such as the inside of a tunnel and an upper part of a bridge where a vehicle driver directly cannot see, and providing dangerous road information to the vehicle driver in advance in real-time.

Also, the present invention can raise effectiveness and reliability by sensing and providing constantly changing dangerous road information in real-time.

The present invention can be applied to traffic accident statistics and analysis in a dangerous region by additionally storing the dangerous road information in a base station.

The present invention can provide dangerous road information service not for a specific region, but for a wide region such as the entire inside of the tunnel and the entire upper portion of the bridge based on a wide sensing region and a wide communication region of a sensor node.

That is, the present invention can prevent traffic accidents in the dangerous region based on a simple wireless sensor network infrastructure including sensor nodes and a base station, a wireless communication environment of a vehicle and the base station, and a real-time network routing and information process technology.

### DESCRIPTION OF DRAWINGS

The above and other objects and features of the present invention will become apparent from the following description of the preferred embodiments given in conjunction with the accompanying drawings, in which:

FIG. 1 shows a system for providing dangerous road information based on Ubiquitous Sensor Network (USN) in real-time in accordance with an embodiment of the present invention;

FIG. 2 is a block diagram showing the system for providing the dangerous road information in real-time based on USN in accordance with the embodiment of the present invention; and

FIG. 3 is a flowchart illustrating a method for providing the dangerous road information in real-time based on USN in accordance with an embodiment of the present invention.

### BEST MODE FOR THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on prior art may obscure the points of the present invention, the detailed description will not be provided herein. The preferred embodiments of the present invention will be described in detail hereinafter with reference to the attached drawings.

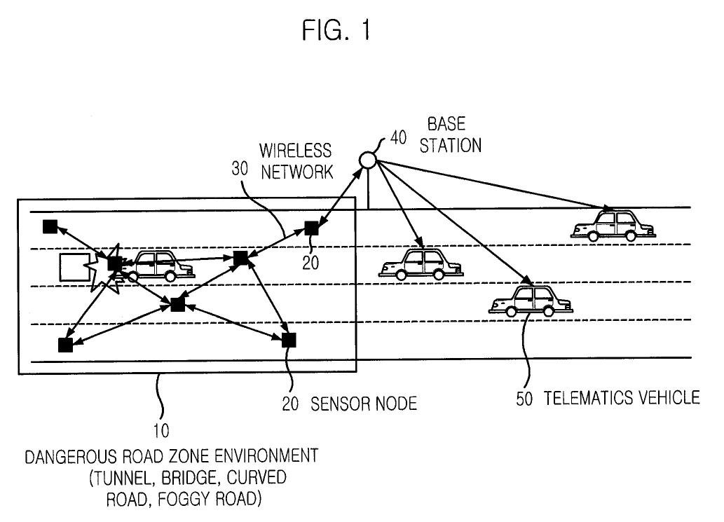

FIG. 1 shows a system for providing dangerous road information based on Ubiquitous Sensor Network (USN) in real-time in accordance with an embodiment of the present invention.

Dangerous road zones such as an inside road of a tunnel, a road on a bridge, a curved road, a road of a foggy region and a road of a commonly dangerous region, which are invisible to a driver, are included in a dangerous road zone environment 10.

A sensor node 20 senses candidate dangerous road information such as a collision accident of vehicles, a fire accident, a load falling accident, a road damage accident, a road flooding accident, a slippery road, and sudden appearance of a pedestrian, which can be generated in the dangerous road zone environment 10, in real-time and extracts exact dangerous road information. The sensor node 20 creates exact dangerous road information of each dangerous road zone by synthetically using temperature, humidity, infrared rays, heat and laser and using own computing capability. Subsequently, the sensor node 20 transmits the created dangerous road information to a base station 40 through the wireless network 30.

The wireless network 30 is a network including short distance wireless communications between a plurality of sensor nodes 20. The wireless network 30 transmits the dangerous road information sensed by each sensor node 20 in overall dangerous road zones to the base station 40 in real-time through the short distance communications between the neighboring sensor nodes 20.

The base station 40 collects and processes all dangerous road information sensed by sensor nodes 20 mounted in all dangerous road zones through the wireless network 30. The base station 40 is established on a start point of the dangerous road zone environment 10 to process and previously provide the collected dangerous road information to the Telematics vehicles in real-time. The base station 40 additionally stores and applies dangerous road information to the traffic accident statistics and analysis later on.

A Telematics vehicle 50 pre-receives dangerous road information provided from the base station 40 established on the start point of the dangerous road zone environment 10 before entering the dangerous road zone and notifies the dangerous road information to the driver.

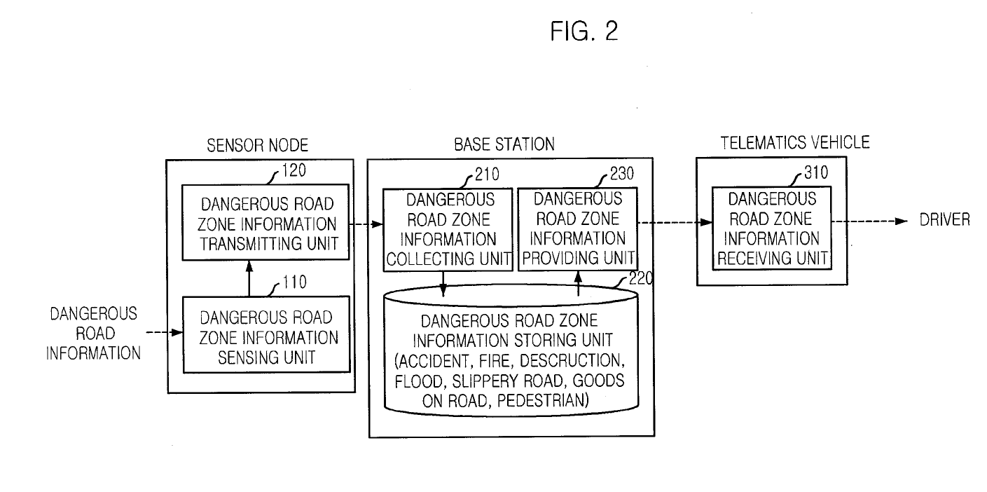

FIG. 2 is a block diagram showing the system for providing the dangerous road information in real-time based on USN in accordance with the embodiment of the present invention.

The sensor node 20 includes a dangerous road zone information sensing unit 110 and a dangerous road zone information transmitting unit 120. The base station 40 includes a dangerous road zone information collecting unit 210, a dangerous road zone information storing unit 220, and a dangerous road zone information providing unit 230. The Telematics vehicle 50 includes a dangerous road zone information receiving unit 310.

The system for providing dangerous road information in real-time based on USN of the present invention includes the dangerous road zone information sensing unit 110 and the dangerous road zone information transmitting unit 120, the dangerous road zone information collecting unit 210, the dangerous road zone information storing unit 220, and the dangerous road zone information providing unit 230.

The dangerous road zone information sensing unit 110 has a sensing function for sensing diverse information such as a temperature, humidity, heat, and infrared rays in a dangerous road zone and a computing function for analyzing the sensed information and extracting exact dangerous road information.

The dangerous road zone information transmitting unit 120 transmits the dangerous road information extracted from the dangerous road zone information sensing unit 110 through the short distance wireless network.

The dangerous road zone information collecting unit 210 collects all dangerous road information transmitted from the dangerous road zone information transmitting unit 120 and checks duplication elimination and unification of the dangerous road information.

The dangerous road zone information storing unit 220 stores dangerous road information collected and processed in the dangerous road zone information collecting unit 210 to use the dangerous road information in a real-time vehicle service and a periodic traffic information service.

The dangerous road zone information providing unit 230 previously provides the dangerous road information stored in the dangerous road zone information storing unit 220 in real-time to the Telematics vehicles accessing to the dangerous road zone through a wireless communication.

The dangerous road zone information receiving unit 310 established in the Telematics vehicle pre-receives the information of the dangerous road zone provided from the dangerous road zone information providing unit 230 through the wireless communication and notifies the information of the dangerous road zone to the driver.

The dangerous road zone information storing unit 220 is an additional constitutional element of the present invention. Accordingly, the dangerous road zone information providing unit 230 is operated according to a method for receiving the dangerous road information from the dangerous road zone information collecting unit 210 and providing the dangerous road information.

The sensor nodes 20 are arranged according to a sensing range and a wireless communication range of the sensor node in the dangerous road zone environment 10 such as an inside of a tunnel, an upper part of a bridge and a curved road. There are two things to be considered in arrangement of the sensor node. First, all sensor nodes should be able to be connected to the base station 40 through a short distance wireless communication between the sensor nodes. Second, the sensing range of the arranged sensor nodes should cover all region of the dangerous road zone. Therefore, the number of the sensor node 20 arranged in the dangerous road zone of the present invention is changed according to the two considerations.

The dangerous road zone information sensing unit 110 in the inside of the sensor node senses candidate information which may be a dangerous element in the dangerous road zone based on the function for sensing diverse information such as temperature, humidity, heat, and infrared rays. The dangerous road zone information sensing unit 110 extracts the dangerous road information by uniting and analyzing the sensed candidate dangerous road information based on the computing function of the dangerous road zone information sensing unit 110. Since it is very difficult to raise exactness by sense information through one sensing device, i.e., one sensing function in the dangerous road information extracting process, it is preferred to raise reliability of the dangerous road information by uniting and analyzing at least two sense information, and considering and analyzing diverse dangerous road zone environments 10 such as the tunnel and the bridge. The dangerous road information which can be sensed in the dangerous road zone information sensing unit 110 includes a collision accident of vehicles, a fire accident, a load falling accident, a road damage accident, a road flooding accident, road freezing, and sudden advent of a pedestrian.

The dangerous road zone information transmitting unit 120 in the inside of the sensor node transmits the dangerous road information sensed by each sensor node based on the short distance wireless communication between sensor nodes to the base station 40. It should be importantly considered that a dualization fixed routing method is adopted as a wireless network routing method between the sensor nodes 20 and the base station 40 in the present invention. In dualization fixed routing method, a network path for transmitting the dangerous road information between the sensor nodes 20 and the base station 40 is generally fixed differently from the adhoc network routing and it means that there are two fixed network paths. The dualization fixed routing method can raise reliability in dangerous road information transmission due to dualization routing and can improve real-time performance in dangerous road information transmission by fixed routing.

The base station 40 is positioned at a point that the dangerous road zone starts. The base station 40 can be established in a place where the wireless communication with the sensor nodes 20 is possible. The dangerous road zone information collecting unit 210 in the inside of the base station collects all dangerous road information sensed by the sensor nodes 20, processes and stores the information in the dangerous road zone information storing unit 220. Herein, a procedure for processing the collected dangerous road information is very important. The processing procedure includes a duplication check searching whether the collected dangerous road information is the same as the pre-collected information, a unification check for searching whether the collected dangerous road information can be united into one information, and a simplifying function for transforming the collected dangerous road information into information of a simple format to provide the collected dangerous road information to the vehicle. An object of the dangerous road information processing procedure is to remove duplication of the information, raise reliability of the information and improve real-time performance of the information transmission.

The dangerous road zone information storing unit 220 stores the processed dangerous road information which is used to provide the dangerous road information to the vehicle in real-time and required for being periodically provided to the traffic information center for traffic information statistics and analysis. The dangerous road zone information storing unit 220 is an additional element of the present invention.

The dangerous road zone information providing unit 230 reads the dangerous road information stored in the dangerous road zone information storing unit 220, or receives the dangerous road information from the dangerous road zone information collecting unit 210 and transmits the dangerous road information to all vehicles accessing to the dangerous road zone through the short distance wireless communication such as the Radio Access Network (RAN) in real-time. The present invention simultaneously uses a method for providing the dangerous road information directly to the vehicle through the wireless communication and a method for indirectly providing the same dangerous road information based on the VMS established in the base station 40. Information becomes sophisticated by differently specializing the information provided on the VMS and the information directly provided to the vehicle although the same dangerous road information is provided. For example, when a collision accident of 5 vehicles is generated at the first and second lanes of the tunnel, information is provided in a simple and short form such as “accident has occurred in tunnel” on the VMS. In addition, detailed information is provided such as “Collision accident of 5 vehicles is generated at the first and second lanes of a distance of 200 m from the tunnel as of 12:30, and traffic is congested at a distance of 100 m from the spot where the accident took place” in the vehicle through wireless communication. The detailed information is formed to raise exactness of the information by updating the information as soon as possible.

The Telematics vehicle 50 receives the detailed dangerous road information continuously updated until entering the dangerous road zone through wireless communication with the base station 40 and transmits the detailed dangerous road information to the driver. Accordingly, the dangerous road zone information receiving unit 310 capable of wireless communication is mounted in the inside of the Telematics vehicle.

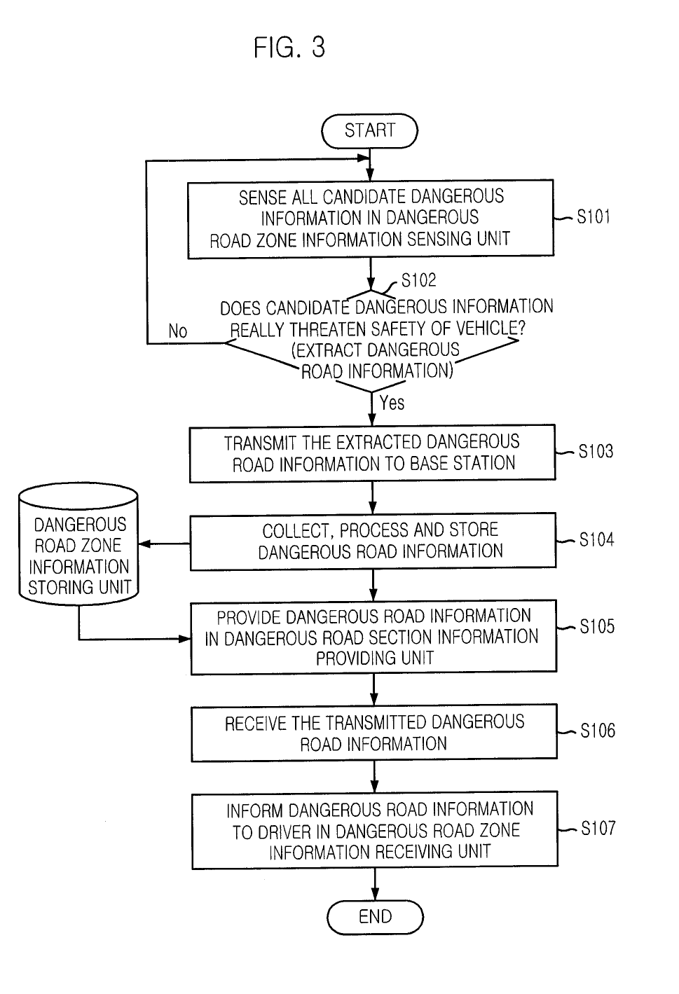

FIG. 3 is a flowchart illustrating a method for providing the dangerous road information in real-time based on USN in accordance with an embodiment of the present invention.

The dangerous road zone information sensing unit 110 senses all information which may be dangerous road information at step S101 and extracts dangerous road information through an analyzing method described in FIG. 2 on all sensed candidate dangerous road information at step S102.

The dangerous road zone information transmitting unit 120 transmits the dangerous road information to the base station according to a dualization fixed routing method in the wireless communication environment between the sensor nodes and the base station at step S103.

The dangerous road zone information collecting unit 210 of the base station performs the processing procedure such as duplication elimination, unification and simplification on the dangerous road information collected from the sensor nodes and stores the dangerous road information in the dangerous road zone information storing unit 220 at step S104. Herein, the storing procedure is an additional element of the present invention.

The dangerous road zone information providing unit 230 reads the dangerous road information stored in the dangerous road zone information storing unit 220, or receives the dangerous road information from the dangerous road zone information collecting unit 210 and provides the dangerous road information to the vehicles entering the dangerous road zone environment in real-time at step S105.

The dangerous road zone information receiving unit 310 of the vehicle receives the dangerous road information transmitted from the dangerous road zone information providing unit 230 of the base station at step S106 and notifies the information to the driver at step S107.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

1. A system for providing dangerous road information in real-time based on Ubiquitous Sensor Network (USN), comprising:
a dangerous road zone information sensing means having a sensing function for sensing diverse information in a dangerous road zone and a computing function for extracting dangerous road information by analyzing the sensed information;
a dangerous road zone information transmitting means for transmitting the extracted dangerous road information through a short distance wireless network;
a dangerous road zone information collecting means for collecting the transmitted dangerous road information and checking duplication elimination and unification of the dangerous road information; and
a dangerous road zone information providing means for providing the dangerous road information collected and processed in the dangerous road zone information collecting means to a Telematics vehicle approaching to the dangerous road zone in real-time through wireless communication.

2. The system as recited in claim 1, further comprising:
a dangerous road zone information storing means for storing the dangerous road information collected and processed in the dangerous road zone information collecting means to use the dangerous road information in a real-time vehicle service and a periodic traffic information service.

3. The system as recited in claim 1, wherein the wireless network is formed by including the dangerous road zone information sensing means and the dangerous road zone information transmitting means in each sensor node, and arranging a plurality of sensor nodes according to a sensing range and a wireless communication range of the sensor node.

4. The system as recited in claim 1, wherein the dangerous road zone information sensing means senses candidate information which threatens safety of a vehicle in the dangerous road zone based on the sensing function for sensing diverse information including temperature, humidity, heat and infrared rays, and extracting the dangerous road information by unifying and analyzing the sensed candidate dangerous road information and the dangerous road zone environment based on the computing function.

5. The system as recited in claim 1, wherein the dangerous road zone information transmitting means transmits the dangerous road information according to a dualization fixed routing method.

6. The system as recited in claim 1, wherein the dangerous road zone information collecting means collects all dangerous road information transmitted from the dangerous road zone information transmitting means and performs functions of duplication check for searching whether the collected dangerous road information is the same as the pre-collected information, a unification check for searching whether the collected dangerous road information can be united into one information, and a simplifying function for changing the collected dangerous road information into information of a simple format to provide the collected dangerous road information to the vehicle.

7. The system as recited in claim 1, wherein the dangerous road zone information providing means provides the dangerous road information by simultaneously using a method for providing the dangerous road information directly to the vehicle through the wireless communication and a method for indirectly providing the same dangerous road information on the VMS.

8. A method for providing dangerous road information in real-time based on a Ubiquitous Sensor Network (USN), comprising the steps of:
a) sensing candidate dangerous road information for dangerous road information
b) extracting dangerous road information from the sensed candidate dangerous road information;
c) transmitting the extracted dangerous road information through a wireless network;
d) collecting the transmitted dangerous road information and performing duplication elimination, unification and simplification; and
e) providing the collected and processed dangerous road information to a Telematics vehicle approaching to a dangerous road zone environment in real-time.

9. The method as recited in claim 8, further comprising the step of:
f) storing the collected and processed dangerous road information to be used for the dangerous road information in a real-time vehicle service and a periodic traffic information service.

10. The method as recited in claim 8, wherein in the step c), the dangerous road information is transmitted according to a dualization fixed routing method.
